(19) United States
(12) Patent Application Publication
(10) Pub. No.: US 2021/0106982 A1
(43) Pub. Date: Apr. 15, 2021

(54) METHOD FOR PREPARING BIOCL PHOTOCATALYST WITH SUPER STRONG DEGRADATION EFFECT

(71) Applicant: Harbin Normal University, Harbin (CN)

(72) Inventor: Mingyi ZHANG, Harbin (CN)

(73) Assignee: Harbin Normal University, Harbin, Heilongjiang (CN)

(21) Appl. No.: 17/038,897

(22) Filed: Sep. 30, 2020

(30) Foreign Application Priority Data
Oct. 14, 2019 (CN) 201910971427.9
Aug. 12, 2020 (CN) 202010806840.2

(51) Int. Cl. B01J 35/00; B01J 37/04; B01J 37/06; B01J 35/02; C01G 29/00; B01J 27/06; B01D 53/86; C02F 1/30; C02F 1/72

(52) U.S. Cl. CPC B01J 35/004; B01J 37/04; B01J 37/06; B01J 35/023; C01G 29/00; B01J 27/06; C02F 2101/34; C02F 1/30; C02F 1/725; B01D 2255/70; B01D 2255/802; B01D 2257/704; B01D 53/8668

(57) ABSTRACT

The present invention discloses a BiOCl photocatalyst with a super degradation effect. BiOCl is prepared into a special micro-nano ellipsoid structure which significantly improves catalysis efficiency under visible light. With the present invention, degradation rates with gas phase formaldehyde, Congo red solution and hexavalent chromium solution can reach above 90%. Moreover, due to a stable structure, the BiOCl photocatalyst has desired reusability which enables a lower cost of the photocatalyst and wider use in the field of environmental pollution treatment.

### CROSS-REFERENCE TO RELATED APPLICATIONS

This application is a non-provisional utility application which claims priority to CN 201910971427.9, filed Oct. 14, 2019, and CN 202010806840.2, filed Aug. 12, 2020, the entire contents of which application are herein incorporated by reference.

### TECHNICAL FIELD

The present invention relates to the technical field of photocatalysts, in particular to a method for preparing a BiOCl photocatalyst with a super strong degradation effect.

### BACKGROUND

Semiconductor-based photocatalysis technology has become one of the methods for effective degradation of water pollutants. Compared with other methods (for example, filtration, adsorption, and biotechnology), it has advantages such as clean, harmless, low price and possible of using sunlight. For example, semiconductor materials such as TiO₂ and ZnO have been applied in photodegradation of pollutants in sewage. However, these materials have a large forbidden band gap (>3.0 eV) and only use ultraviolet light in sunlight. Therefore, a catalyst highly responsive to visible light is an inevitable trend.

BiOCl is a semiconductor with a band gap of 3.46 eV but can only use ultraviolet light in sunlight, which limits its practical application. How to improve morphology of a material through improvement of a preparation method and thereby improve photocatalytic performance of the material is a focus of researches in this field. Therefore, the present invention provides a method for preparing a BiOCl photocatalyst with a super strong degradation effect.

### SUMMARY

Based on the technical problems existing in the background art, the present invention proposes a method for preparing a BiOCl photocatalyst with a super strong degradation effect.

A technical solution of the present invention is as follows:

A method for preparing a BiOCl photocatalyst with a super strong degradation effect, including the following steps:

step A. dissolving an appropriate amount of bismuth nitrate in a mixed solution of deionized water and ethanol to achieve a concentration of 0.1-0.3 mol/L, and stirring to obtain a clear solution;

step B. adding ammonium chloride, glycerin and oleic acid to the above solution, and stirring evenly;

step C. transferring a mixed solution obtained in step B to a stainless steel reactor with a polytetrafluoroethylene lining, heating at 120-150° C. for 8-12 h, and cooling naturally;

step D. filtering, washing a solid with ethanol repeatedly for 3-5 times and spray drying.

Preferably, in step A, a volume ratio of the deionized water to the ethanol is 1:(6-10).

Preferably, in step B, the ammonium chloride is 2-4 times the mass of the bismuth nitrate.

Preferably, in step B, a volume ratio of the oleic acid to the ethanol is (1-3):10, and a volume ratio of the glycerol to the ethanol is (0.2-0.5):10.

The present invention has the following advantages: the BiOCl photocatalyst with a super degradation effect prepared by the present invention has significantly improved catalysis efficiency under visible light by preparing the BiOCl into a special micro-nano ellipsoid structure with a length of 300-800 nm, a width of 150-300 nm and a thickness of 50-100 nm. Moreover, due to a stable structure, the BiOCl photocatalyst has desired reusability which enables a lower cost of the photocatalyst and wider use in the field of environmental pollution treatment.

### DETAILED DESCRIPTION

### Example 1

A method for preparing a BiOCl photocatalyst with a super strong degradation effect included the following steps:

step A. an appropriate amount of bismuth nitrate was dissolved in a mixed solution of deionized water and ethanol to achieve a concentration of 0.15 mol/L. Stirring was carried out to obtain a clear solution;

step B. ammonium chloride, glycerin and oleic acid were added to the above solution, and stirred evenly;

step C. a mixed solution obtained in step B was transferred to a stainless steel reactor with a polytetrafluoroethylene lining, heated at 128° C. for 10 h, and cooled naturally;

step D. filtering was carried out. A solid was washed with ethanol repeatedly for 4 times and spray dried.

In step A, a volume ratio of the deionized water to the ethanol was 1:8.5.

In step B, the ammonium chloride was 2.5 times the mass of the bismuth nitrate.

In step B, a volume ratio of the oleic acid to the ethanol was 1.5:10, and a volume ratio of the glycerol to the ethanol was 0.3:10.

### Example 2

A method for preparing a BiOCl photocatalyst with a super strong degradation effect included the following steps:

step A. an appropriate amount of bismuth nitrate was dissolved in a mixed solution of deionized water and ethanol to achieve a concentration of 0.3 mol/L. Stirring was carried out to obtain a clear solution;

step B. ammonium chloride, glycerin and oleic acid were added to the above solution, and stirred evenly;

step C. a mixed solution obtained in step B was transferred to a stainless steel reactor with a polytetrafluoroethylene lining, heated at 150° C. for 8 h, and cooled naturally;

step D. filtering was carried out. A solid was washed with ethanol repeatedly for 5 times and spray dried.

In step A, a volume ratio of the deionized water to the ethanol was 1:6.

In step B, the ammonium chloride was 4 times the mass of the bismuth nitrate.

In step B, a volume ratio of the oleic acid to the ethanol is 1:10, and a volume ratio of the glycerol to the ethanol was 0.5:10.

### Example 3

A method for preparing a BiOCl photocatalyst with a super strong degradation effect included the following steps:

step A. an appropriate amount of bismuth nitrate was dissolved in a mixed solution of deionized water and ethanol to achieve a concentration of 0.1 mol/L. Stirring was carried out to obtain a clear solution;

step B. ammonium chloride, glycerin and oleic acid were added to the above solution, and stirred evenly;

step C. a mixed solution obtained in step B was transferred to a stainless steel reactor with a polytetrafluoroethylene lining, heated at 120° C. for 12 h, and cooled naturally;

step D. filtering was carried out. A solid was washed with ethanol repeatedly for 3 times and spray dried.

In step A, a volume ratio of the deionized water to the ethanol was 1:10.

In step B, the ammonium chloride was 2 times the mass of the bismuth nitrate.

In step B, a volume ratio of the oleic acid to the ethanol was 3:10, and a volume ratio of the glycerol to the ethanol was 0.2:10.

The BiOCl photocatalyst samples prepared in Examples 1-3 were tested (see Table 1 for test results) with test methods as follows:

(1) Gas phase formaldehyde degradation test: formaldehyde was a common indoor pollutant with an indoor maximum allowable concentration of 0.08 mg/m³ according to “GB/T 16127-1995 Hygienic Standard for Formaldehyde in Indoor Air of House”. In this embodiment, a PFD-5060 photochemical reactor (250 L) produced by Hunan Huasi Instrument Co., Ltd. was used to simulate a house environment, and five T5 straight fluorescent tubes (14 W) were used to simulate natural light and illumination sources of the house. The photocatalytic formaldehyde degradation test was carried out with the BiOCl samples obtained in Examples 1-3 as follows:

1 g of a prepared sample was applied on a 50 cm×50 cm glass plate each time. After naturally dried, the sample plate was put into a test chamber. A lifting platform was adjusted, so that the distance between the sample surface and the tube was 20 cm. The test chamber was sealed. Then an accurate 30 μL of 0.016 mg/μL formaldehyde solution was taken with a microsyringe. The formaldehyde entered the test chamber in a form of gas and was evenly dispersed in the chamber through a sample injection device that came with the reactor and an auxiliary heating and ventilation device. Then the tubes and a fan (20 W) were turned on. The photocatalytic reaction was carried out. After lighting for 12 h, 10 L sample was collected with a constant flow air sampler (with a flow rate of 1 L/min and gas collection time of 10 min). Finally, the concentration of formaldehyde was tested in accordance with the national standard “GB/T 16129-1995 Standard Method for Hygienic Examination of Formaldehyde in Air of Residential Areas-Spectrophotometric Method”. A formula for calculating the degradation rate of formaldehyde was η=(C₀−C₁₂)/C₀×100%, where η was the degradation rate, C₀ was the formaldehyde concentration of a blank (no sample) test chamber at the end of the test, and C₁₂ was the formaldehyde concentration of a sample test chamber at the end of the test.

(2) Degradation test with Congo red solution: Congo red was a typical benzidine direct azo dye. A greater degradation rate with a Congo red solution by a sample under certain conditions indicated a better photocatalytic performance. In this specific embodiment, a concentration of the Congo red solution used was 20 mg/L, a light source was a 500 W xenon light (simulating sunlight), and a product was tested on a BL-GHX-V photochemical reactor produced by Shanghai Bilang Instrument Co., Ltd. for photocatalytic performance. Steps were as follows:

100 mL of Congo red solution was mixed with 0.1 g of product each time. Stirring was carried out for 40 min under no light conditions to mix the solution evenly. Then the light was turned on to perform a photocatalytic reaction. After lighting for 5 h, a sample was taken with a centrifuge tube. After high-speed centrifugation, a supernatant was taken and measured at a wavelength of 500 nm on a spectrophotometer for absorbance. A formula for calculating the degradation rate with Congo red solution was: degradation rate=(A₀−Aₜ)/A₀×100%, where A₀ was the absorbance value of the initial Congo red solution, and Aₜ was the absorbance value of the Congo red solution after lighting for 5 h.

(3) Degradation test with hexavalent chromium (Cr(VI)) solution: Cr(VI) can cause typical heavy metal pollution and had strong toxicity. In this specific embodiment, K₂Cr₂O₇ solution was used to simulate Cr(VI) wastewater. Degradation with Cr(VI) solution meant reduction into non-toxic or less toxic trivalent chromium and other substances. The concentration of K₂Cr₂O₇ solution used was 10 mg/L, a light source was a 500 W xenon light (simulating sunlight), and a product was tested on a BL-GHX-V photochemical reactor produced by Shanghai Bilang Instrument Co., Ltd. for photocatalytic performance. A diphenylcarbohydrazide spectrophotometric method (“GB 7467-1987 Water Quality-Determination of Chromium (VI)”) was used to test for the content of Cr(VI). Steps were as follows:

100 mL of Cr(VI) solution was mixed with 0.2 g of product each time. Stirring was carried out for 40 min under no light conditions to mix the solution evenly. Then the light was turned on to perform a photocatalytic reaction. After lighting for 5 h, a sample was taken with a centrifuge tube. After high-speed centrifugation, 2 mL of supernatant was taken and added to a 50 mL colorimetric tube. Distilled water was used to adjust a volume to 50 mL. Then 2 mL of sulfuric acid solution (volume ratio 1:1) and 2 mL of diphenylcarbohydrazide in acetone solution were sequentially added. After development for 10 min, absorbance was measured at 540 nm on a spectrophotometer. A formula for calculating the degradation rate with Cr(VI) solution was: degradation rate=(B₀−Bₜ)/B₀×100%, where B₀ was the absorbance value of the initial K₂Cr₂O₇ solution, and Bₜ was the absorbance value of the K₂Cr₂O₇ solution after lighting for 5 h.

(4) Calculation of forbidden band gap Eg of BiOCl sample: [F(R)hv]^{1/2} with hv was plotted. A straight line part was extrapolated to intersect with the abscissa (a tangent was made on an inflection point), which determined the forbidden band gap. A (Absorbance) was the absorbance in diffuse ultraviolet-visible reflectance.

TABLE 1
Test results of degradation effect of BiOCl
samples prepared in Examples 1-3 on
organic matters (the following degradation rate
test results being average test results
of 5 test samples)

| Sample | Example 1 | Example 2 | Example 3 |
|---|---|---|---|
| Degradation rate of | 98.18 | 96.77 | 97.25 |
| gas phase formaldehyde | | | |
| % | | | |
| Degradation rate with | 93.76 | 92.88 | 92.62 |
| Congo red solution % | | | |
| Degradation rate with | 91.53 | 90.34 | 90.71 |
| Cr (VI) solution % | | | |
| Forbidden band gap Eg | 2.96 | 2.87 | 2.85 |
| of BiOCl sample | | | |

The foregoing description only provides preferred specific embodiments of the present invention, and the protection scope of the present invention is not limited thereto. Any equivalent replacement or modification made according to the technical solutions and the inventive concept of the present invention by a person skilled in the art within a technical scope of the present invention shall fall within the protection scope of the present invention.

What is claimed is:

1. A method for preparing a BiOCl photocatalyst with a super strong degradation effect, comprising the following steps:
step A. dissolving an appropriate amount of bismuth nitrate in a mixed solution of deionized water and ethanol to achieve a concentration of 0.1-0.3 mol/L, and stirring to obtain a clear solution;
step B. adding ammonium chloride, glycerin and oleic acid to the above solution, and stirring evenly;
step C. transferring a mixed solution obtained in step B to a stainless steel reactor with a polytetrafluoroethylene lining, heating at 120-150° C. for 8-12 h, and cooling naturally;
step D. filtering, washing a solid with ethanol repeatedly for 3-5 times and spray drying.

2. The method for preparing a BiOCl photocatalyst with a super strong degradation effect according to claim 1, wherein, in step A, a volume ratio of the deionized water to the ethanol is 1:(6-10).

3. The method for preparing a BiOCl photocatalyst with a super strong degradation effect according to claim 1, wherein, in step B, the ammonium chloride is 2-4 times the mass of the bismuth nitrate.

4. The method for preparing a BiOCl photocatalyst with a super strong degradation effect according to claim 1, wherein, in step B, a volume ratio of the oleic acid to the ethanol is (1-3):10, and a volume ratio of the glycerol to the ethanol is (0.2-0.5):10.

5. The method for preparing a BiOCl photocatalyst with a super strong degradation effect according to claim 1, wherein, the method comprises the following steps:
step A. dissolving an appropriate amount of bismuth nitrate in a mixed solution of deionized water and ethanol to achieve a concentration of 0.15 mol/L, and stirring to obtain a clear solution;
step B. adding ammonium chloride, glycerin and oleic acid to the above solution, and stirring evenly;
step C. transferring a mixed solution obtained in step B to a stainless steel reactor with a polytetrafluoroethylene lining, heating at 128° C. for 10 h, and cooling naturally;
step D. filtering, washing a solid with ethanol repeatedly for 4 times and spray drying;
wherein, in step A, a volume ratio of the deionized water to the ethanol is 1:8.5;
in step B, the ammonium chloride is 2.5 times the mass of the bismuth nitrate; and
in step B, a volume ratio of the oleic acid to the ethanol is 1.5:10, and a volume ratio of the glycerol to the ethanol is 0.3:10.

6. A BiOCl photocatalyst prepared by the method for preparing a BiOCl photocatalyst with a super strong degradation effect according to claim 1.

7. A BiOCl photocatalyst prepared by the method for preparing a BiOCl photocatalyst with a super strong degradation effect according to claim 2.

8. A BiOCl photocatalyst prepared by the method for preparing a BiOCl photocatalyst with a super strong degradation effect according to claim 3.

9. A BiOCl photocatalyst prepared by the method for preparing a BiOCl photocatalyst with a super strong degradation effect according to claim 4.

10. A BiOCl photocatalyst prepared by the method for preparing a BiOCl photocatalyst with a super strong degradation effect according to claim 5.
